(19) United States
(12) Patent Application Publication
(10) Pub. No.: US 2025/0362851 A1
(43) Pub. Date: Nov. 27, 2025

(54) IMAGE FORMING APPARATUS, CONTROL METHOD OF IMAGE FORMING APPARATUS, AND RECORDING MEDIUM

(71) Applicant: CANON KABUSHIKI KAISHA, Tokyo (JP)

(72) Inventor: Sho Nakamura, Tokyo (JP)

(21) Appl. No.: 19/207,729

(22) Filed: May 14, 2025

(30) Foreign Application Priority Data
May 24, 2024 (JP) 2024-084669

(51) Int. Cl. G06F 3/12

(52) U.S. Cl. CPC G06F 3/1259; G06F 3/1207; G06F 3/121; G06F 3/1251; G06F 3/1267

(57) ABSTRACT

One or more processors of an image forming apparatus executes the instructions to: perform a reception process of receiving a print instruction of continuously printing a plurality of jobs including a second job subsequent to a first job; and perform a control process of controlling output of predetermined notification before execution of a print process of a foremost job among the plurality of jobs, based on reception of a print instruction for the foremost job, in a case where a condition in which a print process is interrupted after completion of printing of the first job and before start of printing of the second job is satisfied in the reception of the print instruction in the reception process.

### BACKGROUND OF THE INVENTION

### Field of the Invention

The present disclosure relates to an image forming apparatus, a control method of the image forming apparatus, and a recording medium.

### Description of the Related Art

There is a technique in which, in the case where printing based on a print job is to be executed on a roll paper, a sheet amount of the print job is compared with a remaining amount of the roll paper and a rewindable amount on the roll paper rewinding side to check whether printing based on the print job is possible. Japanese Patent Laid-Open No. 2016-124281 (hereinafter, referred to as Literature 1) discloses a technique in which, in the case where the rewindable amount on the roll paper rewinding side is insufficient for a sheet length required for the next job, a warning screen warning insufficiency of the rewindable amount is displayed. In Literature 1, in the case where printing based on multiple print jobs is executed, a printing operation is temporarily stopped after completion of printing based on the first print job, and then whether printing of the subsequent job is possible is checked.

There is a demand for performing notification at an appropriate timing in the case where printing is continuously performed by using multiple print jobs.

### SUMMARY OF THE INVENTION

An image forming apparatus according to one aspect of the present disclosure includes: one or more memories storing instructions; and one or more processors executing the instructions to: perform a reception process of receiving a print instruction of continuously printing a plurality of jobs including a second job subsequent to a first job; and perform a control process of controlling output of predetermined notification before execution of a print process of a foremost job among the plurality of jobs, based on reception of a print instruction for the foremost job, in a case where a condition in which a print process is interrupted after completion of printing of the first job and before start of printing of the second job is satisfied in the reception of the print instruction.

Further features of the present invention will become apparent from the following description of exemplary embodiments with reference to the attached drawings.

### BRIEF DESCRIPTION OF THE DRAWINGS

FIG. 1 is a diagram illustrating an example of a schematic configuration of an image forming apparatus;

FIG. 2 is a functional block diagram illustrating a control configuration of the image forming apparatus;

FIG. 3 is an example of a UI screen in which a list of print jobs is displayed;

FIG. 4 is a diagram showing the relationship of FIGS. 4A and 4B.

FIGS. 4A and 4B are totally a flowchart illustrating an example of a process up to a point where printing is started;

FIG. 5 is a diagram illustrating an example of a confirmation screen;

FIGS. 6A to 6C are diagrams illustrating examples of confirmation screens;

FIGS. 7A to 7C are diagrams illustrating examples of display of printable jobs;

FIG. 8 is a flowchart in which a sheet length is calculated from selected jobs;

FIG. 9 is a diagram showing the relationship of FIGS. 9A and 9B.

FIGS. 9A and 9B are totally a detailed flowchart of a process of checking print settings of the selected jobs;

FIGS. 10A and 10B are diagrams illustrating examples of screens in which a warning is displayed;

FIGS. 11A and 11B are diagrams illustrating examples of screens in which a warning is displayed;

FIGS. 12A to 12C are diagrams illustrating examples of screens in which a warning is displayed; and

FIGS. 13A to 13C are diagrams explaining calculation of the sheet length.

### DESCRIPTION OF THE EMBODIMENTS

Preferable embodiments of the present disclosure are explained below in detail with reference to the attached drawings. Note that the following embodiments do not limit the matters of the present disclosure, and not all of combinations of characteristics explained in the following embodiments are necessarily essential for solving means of the present disclosure. Note that the same constituent elements are denoted by the same reference numerals.

### First Embodiment

### Outline

First, an outline of a first embodiment is explained. In an image forming apparatus, as described above, a sheet amount of a print job is compared with a remaining amount of a roll paper and a rewindable amount on the roll paper rewinding side to check whether printing based on the print job is possible, and in the case where the printing is impossible, a warning is displayed. Moreover, there is a form in which the image forming apparatus performs continuous printing by using multiple print jobs. In a mode in which a printing operation is temporarily stopped after completion of printing of the first print job and whether printing of subsequent job is possible is checked in execution of the printing based on the multiple print jobs, comparison with the sheet amount corresponding to the multiple print jobs is not performed. Accordingly, the warning cannot be precisely displayed at an appropriate timing.

Moreover, a sheet needs to be conveyed by predetermined amounts, irrespective of print contents (print image) at start and completion of the printing. The conveyance amounts necessary at the start and completion of the printing as described above also need to be taken into consideration for the sheet amount used in the comparison determination in some cases. In the case where the printing is started without taking these conveyance amounts into consideration, there is a possibility that sheet shortage occurs while printing of the subsequent job is executed.

Moreover, in the case where a print setting of the print job vary in the execution of continuous printing based on the multiple print jobs, printing sometimes stops between the jobs to change the print setting. It is difficult for a user to know whether the printing can be continuously performed or is temporarily interrupted between the jobs in the execution of continuous printing based on the multiple print jobs.

In the present embodiment, explanation is given of an example in which notification is outputted at an appropriate timing in the case where printing based on multiple print jobs is continuously performed. Specifically, explanation is given of an example in which predetermination notification is performed as necessary before start of printing based on the multiple print jobs (that is before execution of printing of the first print job among continuous jobs).

### Configuration of Image Forming Apparatus

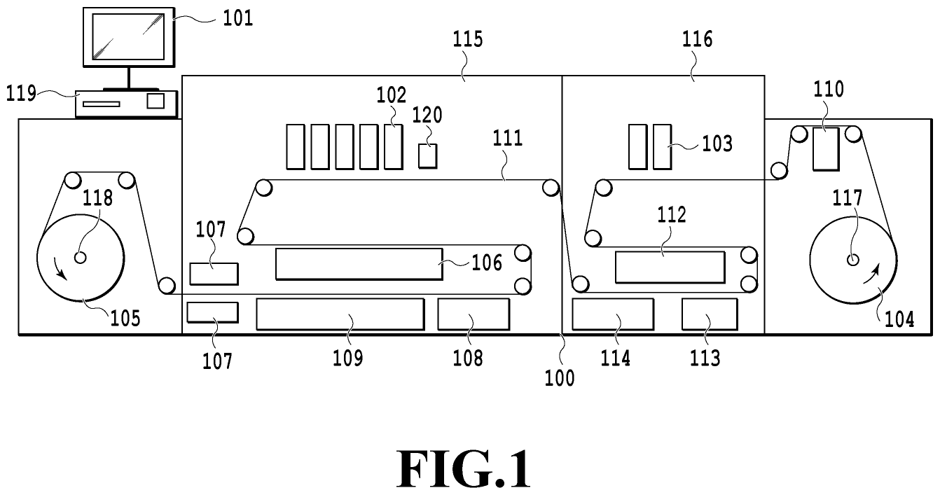

FIG. 1 is a diagram illustrating an example of a schematic configuration of an image forming apparatus in the present embodiment. The image forming apparatus is also an image forming system including multiple devices (units) as described later. The image forming apparatus 100 is an apparatus that forms an image on a continuous print medium (hereinafter, referred to as roll paper) 111 on which continuous printing is possible. In the present embodiment, the image forming apparatus 100 includes a paper feeding device 104 configured to send out the roll paper 111 and a first unit 116 configured to perform particular color printing. The image forming apparatus 100 also includes a second unit 115 configured to perform basic color printing, a paper discharge device 105 configured to perform rewinding of the roll paper 111, and a user interface (hereinafter, referred to as UI) operation panel 101.

The paper feeding device 104 is a device configured to supply the roll paper 111 to an inside of the image forming apparatus 100. The paper feeding device 104 rotates a paper tube of the roll paper 111 about a rotating shaft 117, and conveys the roll paper 111 wound around this paper tube toward the inside of the image forming apparatus 100 at a constant speed via multiple rollers (for example, conveyance rollers, paper feeding rollers, and the like). The paper discharge device 105 is a device configured to rewind the roll paper 111 conveyed inside the image forming apparatus 100, about a paper tube in a roll shape. The paper tube is attached to a rotating shaft 118, and is rotated about the rotating shaft 118 to rewind the roll paper 111 conveyed to the paper tube via multiple rollers (for example, conveyance rollers, paper discharge rollers, and the like) at predetermined speed as a print product. The print product is wound around the paper tube to be held in a roll shape.

As work before start of printing, the user performs work of passing the roll paper 111 from the paper feeding device 104 to the paper discharge device 105. For example, the user sets the roll paper 111 in the paper feeding device 104, and causes a leading edge of the roll paper 111 to pass over a skew correction device 110. Next, the user causes the leading edge of the roll paper 111 to pass under first printing devices 103 of the first unit 116. The first printing devices 103 in the present embodiment are print heads configured to perform printing of a particular color (for example, white ink or the like) other than cyan (C), magenta (M), yellow (Y), and black (K) that are chromatic color inks. The user causes the leading edge of the roll paper 111 to pass under a drying device 112 and to pass over a cooling device 113 and a cooling device 114. Next, the user causes the leading edge of the roll paper 111 to pass under a mark detection sensor 120 and second printing devices 102 of the second unit 115, over a drying device 106, over a cooling device 108, and over a cooling device 109.

In the present embodiment, the mark detection sensor 120 is used for alignment in the case where images of the second printing devices 102 are to be formed on images of the first printing devices 103. However, a scanner may be used instead of the mark detection sensor 120. The second printing devices 102 in the present embodiment are print heads configured to perform printing of print basic colors (CMYK). The user causes the leading edge of the roll paper 111 to pass through a connection scanner device 107, and winds the leading edge around the paper discharge device 105.

After passing the roll paper 111 inside the image forming apparatus 100 as described above, the user inputs print jobs into a control PC (print control apparatus) 119 of the image forming apparatus 100. After inputting the print jobs, the user presses a print start button in the UI operation panel 101. In the case where the image forming apparatus 100 receives this print instruction, the image forming apparatus 100 starts printing. Note that the mark detection sensor 120 reads the printed images, and the control PC 119 analyzes the read images and inspects whether a defect is present in a printed product.

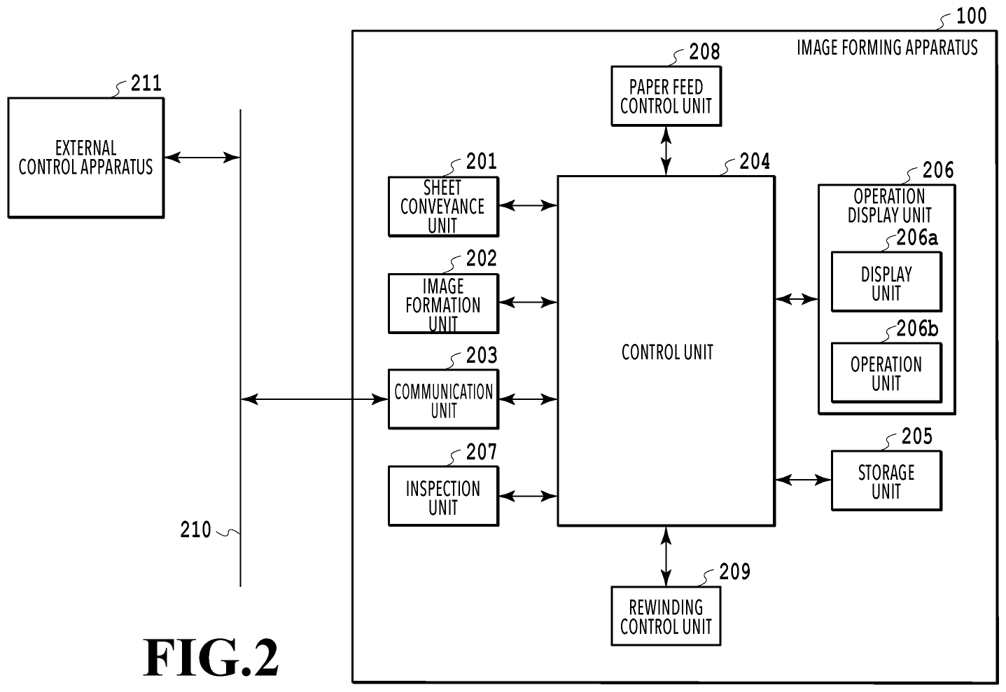

FIG. 2 is a functional block diagram illustrating a control configuration of the image forming apparatus 100. Details of the control configuration of the image forming apparatus 100 are explained by using FIG. 2. As illustrated in FIG. 2, the image forming apparatus 100 includes a sheet conveyance unit 201, an image formation unit 202, a communication unit 203, a control unit 204, a storage unit 205, an operation display unit 206, an inspection unit 207, a paper feed control unit 208, and a rewinding control unit 209.

The sheet conveyance unit 201 is a conveyance mechanism of the roll paper 111 inside the image forming apparatus 100. For example, the sheet conveyance unit 201 uses multiple rollers to convey the roll paper 111 conveyed from the paper feed control unit 208 to the image formation unit 202 and to convey the roll paper 111 having passed the image formation unit 202 to the rewinding control unit 209. The image formation unit 202 forms images on the roll paper 111 supplied from the paper feed control unit 208 based on print data for which an output instruction is received. The image formation unit 202 controls both of the first printing devices 103 and the second printing devices 102. The image formation unit 202 conveys the roll paper 111 on which the images are formed, toward the paper discharge device 105. The communication unit 203 is formed of, for example, a communication control card such as a local area network (LAN) card. The communication unit 203 exchanges various pieces of data with an external control apparatus 211 (for example, personal computer) connected to a communication network 210 such as a LAN or a wide area network (WAN). A print application necessary in printing and the like are installed in the external control apparatus 211.

The control unit 204 includes, for example, a central processing unit (CPU), a random access memory (RAM), and the like. The CPU of the control unit 204 reads various programs such as a system program or a processing program stored in the storage unit 205, loads the programs onto the RAM, and executes various processes according to the loaded programs. For example, the control unit 204 can perform a print process of executing print jobs in response to an instruction of the user. The storage unit 205 is formed of, for example, a non-volatile semiconductor memory (so-called flash memory), a hard disk drive (HDD), or the like. Various programs including the system program or the processing program executed in the control unit 204 and various pieces of data necessary in execution of these programs are stored in the storage unit 205. The operation display unit 206 is formed of, for example, a liquid crystal display (LCD) with a touch panel, and includes a display unit 206a and an operation unit 206b. The operation display unit 206 corresponds to the UI operation panel 101.

The display unit 206a displays various pieces of information on a display screen according to a display control signal received from the control unit 204. The operation unit 206b includes various operation keys such as numerical keys and a start key, receives various input operations by the user, and outputs operation signals to the control unit 204. The operation display unit 206 is used for, for example, setting of job information and like in the case where a job is to be executed. The user can arbitrarily set any of conditions of, for example, a sheet to be used, information on print speed, the number of pages to be printed, the number of copies to be printed, a print length, a print weight, and a print diameter as the setting of job information.

Next, explanation is given of the case where the image forming apparatus 100 performs the print process on the roll paper 111. First, the user creates the print data in an external apparatus such as the external control apparatus 211. The external control apparatus 211 performs print settings of the jobs and delivery volume number setting based on instructions from the user, and transmits these pieces of information to the image forming apparatus 100 via the communication network. The control unit 204 of the image forming apparatus 100 receives image data included in the jobs transmitted from the external control apparatus 211 and job tickets including print setting information of the jobs, delivery volume number information, and the like (hereinafter, referred to as job parameters) via the communication unit 203. The control unit 204 controls the sheet conveyance unit 201, the image formation unit 202, the paper feed control unit 208, the rewinding control unit 209, and the like to perform the print process based on the jobs on the roll paper 111.

The inspection unit 207 is a device configured to check whether the images are printed on the print medium without an ejection failure. The image formation unit 202 prints a detection pattern used in ejection failure inspection, on the print medium. The inspection unit 207 reads the detection pattern with a scanner, and checks whether an ejection failure is present in the printed images. In the case where the ejection failure is detected, the control unit 204 stops the operation of the image forming apparatus 100. A detection method performed in the inspection unit 207 includes various methods such as the method of printing the detection pattern and reading the detection pattern with the scanner, a method of directly reading the printed images with a camera or a scanner, and a method of monitoring a status of ejection from nozzles.

### UI Screen

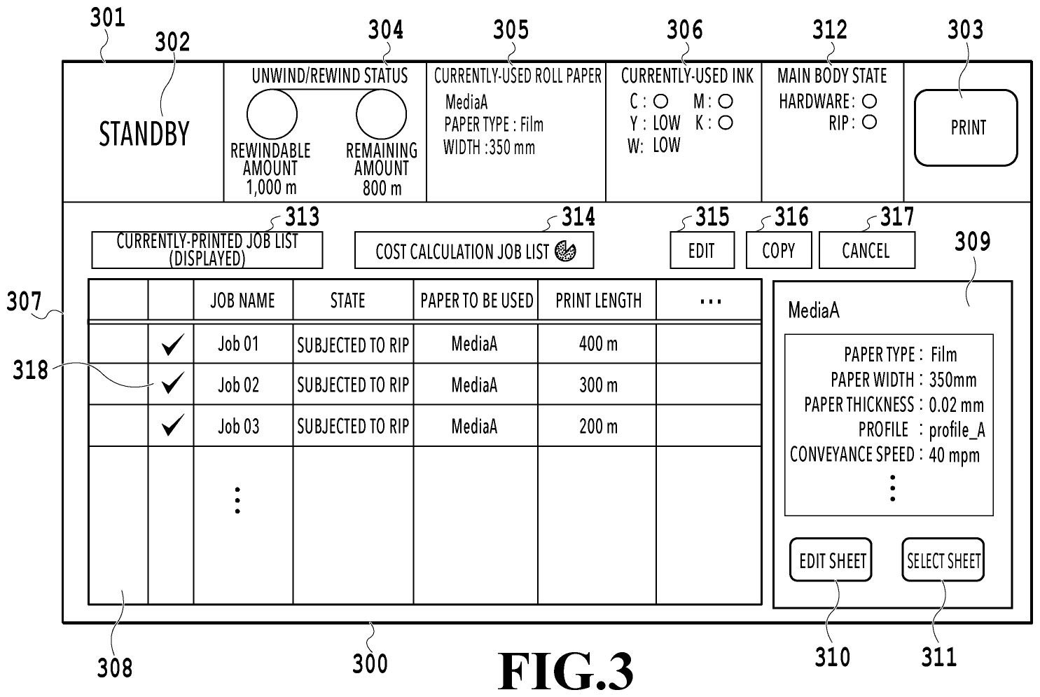

FIG. 3 is an example of a UI screen in which a list of print jobs is displayed in the present embodiment. The UI screen 300 is displayed on the operation display unit 206 (UI operation panel 101). In the case where a job is inputted into the image forming apparatus 100 of the present embodiment, a process of adding this job to the print job list is performed. Then, the image forming apparatus 100 executes a raster image processor (RIP) process on print image data specified in the job at a predetermined timing. In the RIP process, there is performed a process of converting vector image data that is image data described in command to raster image data that is a collection of print pixels. Moreover, there is an RIP process that includes a color conversion function in which colors of the print data are converted. The RIP process may be performed sequentially for the inputted jobs, or may be performed based on designation by the user. The user selects jobs desired to be printed from the print job list, and inputs the print instruction into the image forming apparatus 100. In the case where the image forming apparatus 100 receives this print instruction, the image forming apparatus 100 starts the print process.

Outline information relating to states of the image forming apparatus 100 such as a current state of the image forming apparatus 100 and information on a currently-printed job is displayed in a status display area 301. An operation status display 302 of the image forming apparatus 100 displays a status of the image forming apparatus 100. In FIG. 3, the operation status is “standby” that is a state waiting for printing. The operation status includes states such as “stopped” and “print ongoing” in addition to “standby”. In the case where the image forming apparatus 100 receives pressing of a print button 303, the image forming apparatus 100 displays a print conformation screen. Then, in the case where the image forming apparatus 100 receives pressing of an OK button in the print conformation screen, the image forming apparatus 100 starts printing of the print jobs selected by the user.

In an unwind rewind status display 304, a paper feed remaining amount and a rewindable amount are displayed. In a print medium information display 305, information such as a name and a paper type of the print medium attached to the image forming apparatus 100 is displayed. In an ink state display 306, types and remaining amount states of the used inks are displayed. In a main body state 312, an activation state of hardware and a RIP capable state is displayed. A state in which the hardware is activated is a state in which printing is possible. A state in which the RIP is possible is a state in which the RIP process of the job can be operated.

In the present embodiment, there is illustrated an example in which the display of the operation status of the image forming apparatus 100, the print button, the currently-printed job display, the print medium information display, the ink state display, and the main body state display are displayed as the contents of the status display area 301. However, the present disclosure is not limited to this, and states other than those described above may be displayed in the status display area 301. A work area 307 is a work area for user operation. In the case where detailed information relating to each piece of information in the status display area 301 is to be checked, the user presses a corresponding one of the state display areas in the status display area 301. In the case where the image forming apparatus 100 receives pressing of the state display area, the relating detailed information can be displayed in the work area 307.

In FIG. 3, a print job list 308 is displayed in the work area 307. An ID, a current state, information on the print medium to be used, and the like of each print job are displayed in the print job list 308. The inputted print job is added to the print job list 308. The user selects a job desired to be printed from among the jobs included in the print job list 308. In the case where the image forming apparatus 100 receives pressing of the print button 303 in a state where a job is selected, the image forming apparatus 100 starts printing based on the selected job. The user can select multiple jobs. In the case where the image forming apparatus 100 receives pressing of the print button 303 in a state where multiple jobs are selected, the image forming apparatus 100 starts printing based on the selected multiple jobs.

Detailed information of the print medium is displayed in a print medium information display 309. A sheet edit button 310 is used in the case where the information on the print medium displayed in the print medium information display 309 is to be edited. A sheet selection button 311 is used in the case where new sheet information that is not the currently-set sheet information is to be read. A setting read by using the sheet selection button 311 is displayed in the print medium information display 305 as information on the print medium attached to the image forming apparatus 100.

In the case where the image forming apparatus 100 receives pressing of a cost calculation job list button 314 during display of the print job list 308, the image forming apparatus 100 displays a cost calculation job list in the work area 307. In the present embodiment, in the state where the print job list 308 is displayed, a parameter edit button 315, a copy button 316, and a cancel button 317 for performing operations on the print jobs are displayed. A print selection check 318 is displayed in the case where the user selects a job.

The example illustrated in FIG. 3 illustrates that three jobs of Job01, Job02, and Job03 are in a RIP-subjected state, and are selected. A sheet of Job01 is MediaA, and the print length is 400 m. A sheet of Job2 is MediaA, and the print length is 300 m. A sheet of Job03 is MediaA, and the print length is 200 m. The print lengths are derived by the control unit 204 based on image data subjected to RIP conversion.

### Flowchart up to Print Start

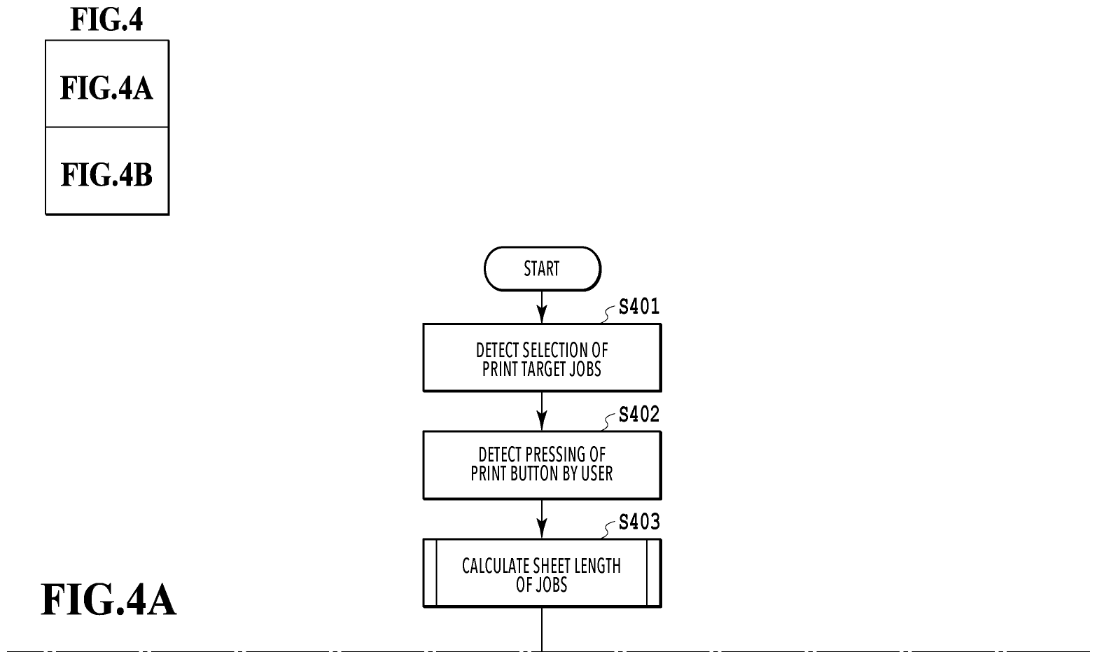

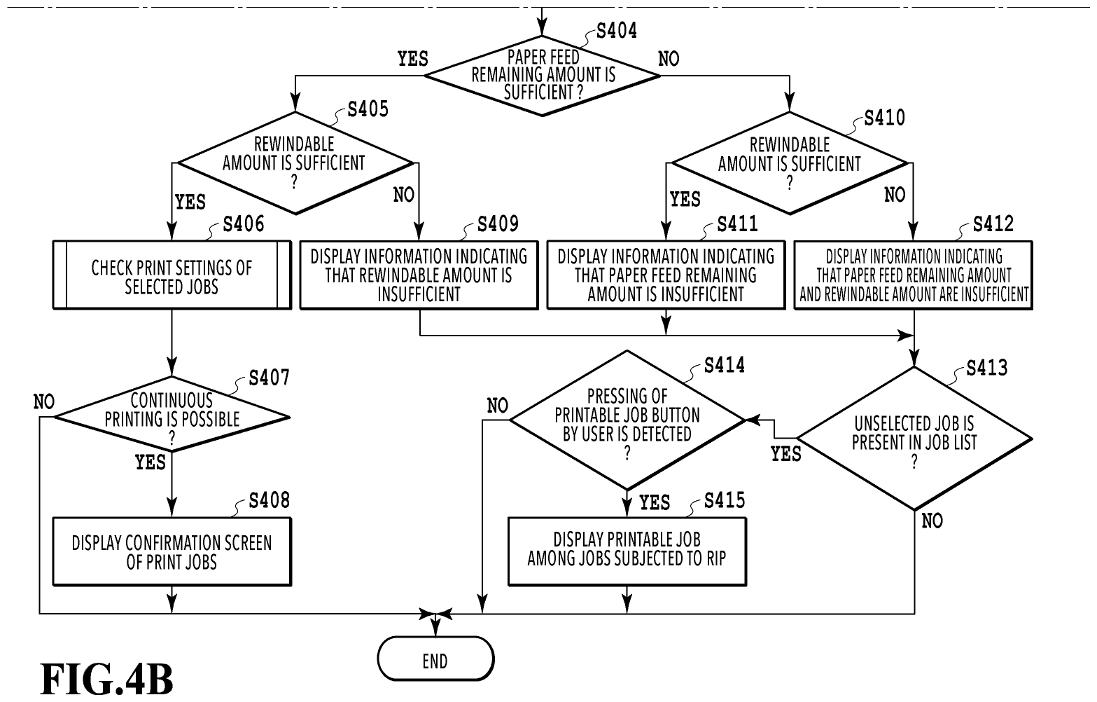

FIGS. 4A and 4B are totally a flowchart illustrating an example of a process up to start of printing. The CPU of the control unit 204 implements the process of flowchart of FIGS. 4A and 4B by reading various programs such as the system program and the processing program stored in the storage unit 205 and loading the programs onto the RAM to execute various processes according to the loaded programs. Note that some or all of functions in the steps in FIGS. 4A and 4B may be implemented by hardware such as an ASIC or an electronic circuit. A symbol “S” in explanation of each process means step in the flowchart (the same applies to the following flowcharts).

FIGS. 4A and 4B are a process start of which is triggered by input of a print job (hereinafter, simply referred to as job) into the image forming apparatus 100. FIGS. 4A and 4B mainly illustrate a control process in a period from a point where a print target job is selected and the print instruction of this job is inputted into the image forming apparatus 100 to a point where the print process is started. Note that, in the process of FIGS. 4A and 4B, it is assumed that the image forming apparatus 100 is in the state where the jobs are inputted and are added to the print job list 308 as described above. Moreover, in the present example, the image forming apparatus 100 is assumed to be in the state where multiple jobs are included in the print job list 308. Furthermore, it is assumed that the RIP process is performed on the jobs included in the print job list 308 under control of the control unit 204, and all jobs are in a state after going to the RIP-subjected state at the start of process of FIG. 4A, for simplification of explanation.

In S401, the control unit 204 detects selection of the print target job by the user. As described above, the jobs inputted into the image forming apparatus 100 are added to the print job list 308. In S401, the control unit 204 detects that the selection of the print job from the print job list 308 is received from the user. Note that the number of selected jobs may be one or more. Although the form assumed in the present embodiment is a form in which multiple jobs are selected, the process in the flowchart of FIGS. 4A and 4B can be applied also to the case where one job is selected. Note that, in the case where multiple jobs are selected and the print instruction is received, the print process of the first job is performed, and then the print process of the second job that is a job subsequent to the first job is performed. In the case where multiple jobs are selected as described above, the print process is performed one by one for each job, instead of performing the print process simultaneously for the multiple jobs.

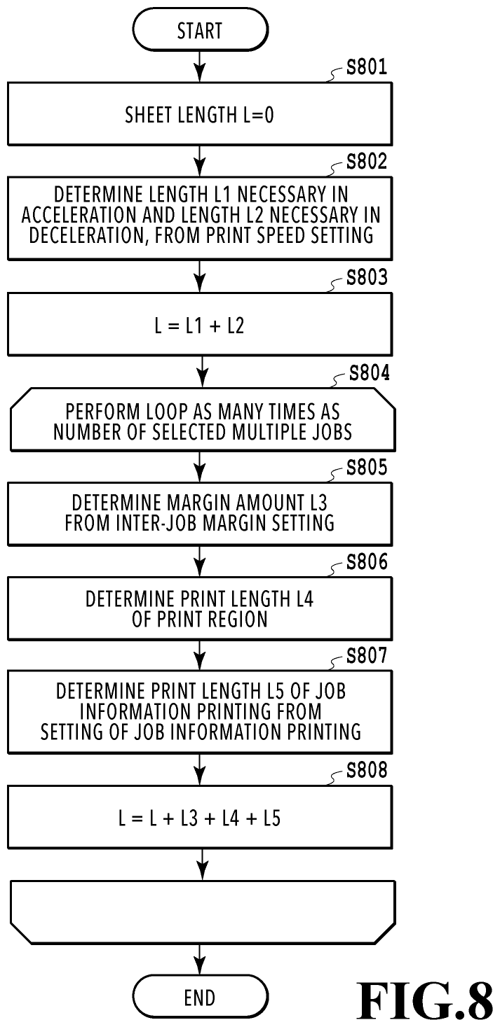

In S402, the control unit 204 detects the pressing of the print button 303 by the user. In S403, the control unit 204 executes a process of calculating a sheet length of the selected jobs. The sheet length of the jobs is a length of sheet necessary for printing the jobs. The sheet length of the jobs includes conveyance amounts in acceleration and deceleration in addition to the print length of the jobs. Details of S403 are explained with reference to the flowchart of FIG. 8 to be described later. Note that, in the case where multiple jobs are selected, the entire sheet length of the multiple jobs is calculated.

In S404, the control unit 204 compares the sheet length of the jobs calculated in S403 with the paper feed remaining amount, and determines whether the paper feed remaining amount is sufficient for the printing of the jobs. For example, the control unit 204 obtains the paper feed remaining amount included in the unwind rewind status display 304. Then, the control unit 204 compares the calculated sheet length of the jobs with the obtained paper feed remaining amount. In the case where the control unit 204 determines that the paper feed remaining amount is sufficient, the control unit 204 proceeds to S405. In the case where the control unit 204 determines that the paper feed remaining amount is insufficient, the control unit 204 proceeds to S410.

In S405, the control unit 204 compares the sheet length of the jobs calculated in S403 with the rewindable amount, and determines whether the rewindable amount is sufficient for the printing of the jobs. For example, the control unit 204 obtains the rewindable amount included in the unwind rewind status display 304. Then, the control unit 204 compares the calculated sheet length of the jobs with the obtained rewindable amount. In the case where the control unit 204 determines that the rewindable amount is sufficient, the control unit 204 proceeds to S406. In the case where the control unit 204 determines that the rewindable amount is insufficient, the control unit 204 proceeds to S409.

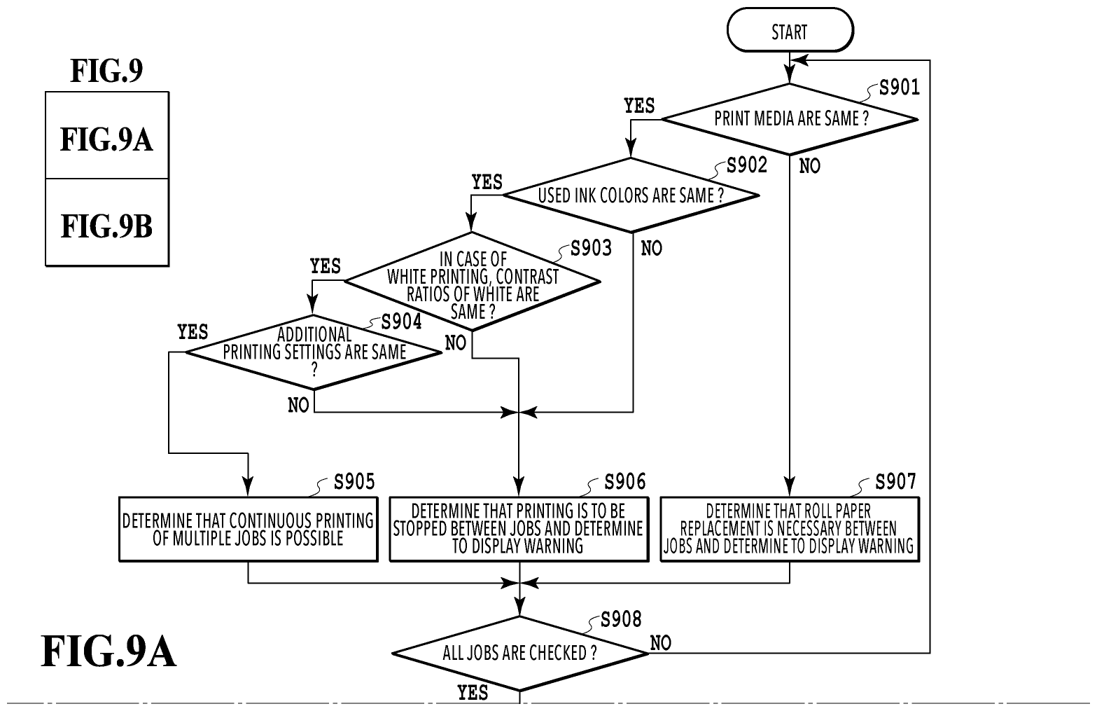

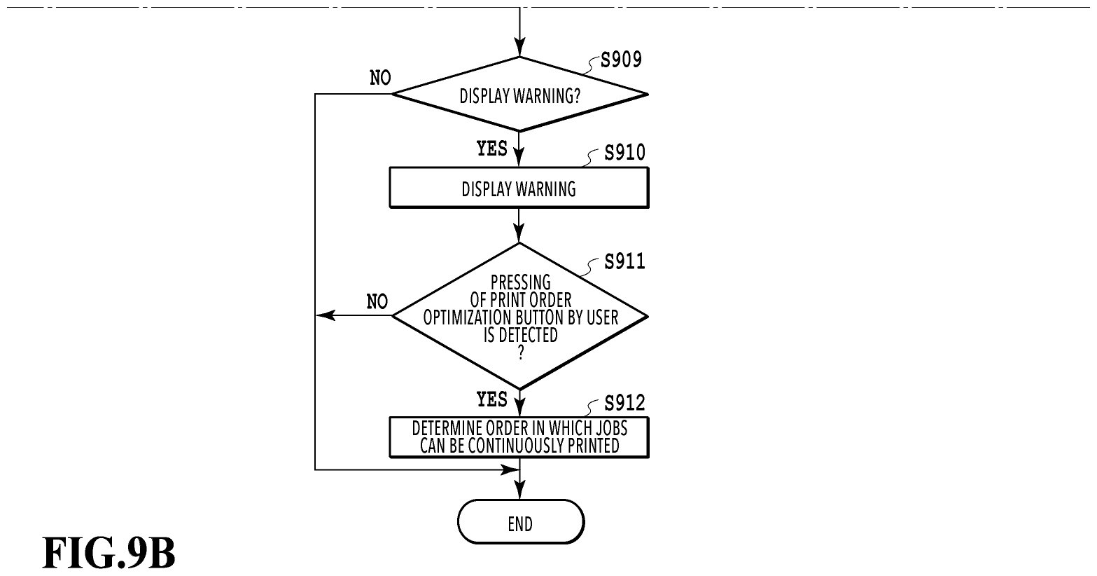

In S406, the control unit 204 executes a process of checking the print settings of the selected jobs. For example, processes such as a process of checking whether the print settings in the selected multiple jobs are the same or not are performed. Details of S406 is explained with reference to the flowchart of FIGS. 9A and 9B to be described later. A state where the process has proceeded to S406 is a state where both of the paper feed remaining amount and the rewindable amount are sufficient. Accordingly, the case where the paper feed remaining amount or the rewindable amount becomes insufficient in the middle of the jobs does not occur. Meanwhile, in the case where the print settings of the jobs vary (for example, presence or absence of usage of white that is a particular color), an operation of temporarily stopping the printing operation and changing the setting is executed due to limitations of the apparatus. Specifically, there is a case where continuous printing of the jobs is temporarily stopped. Accordingly, in S406, the process of checking the print settings of the selected jobs is executed.

Next, in S407, the control unit 204 determines whether the continuous printing is possible. In the case where the control unit 204 determines that the continuous printing is possible in the process of S407, the control unit 204 proceeds to S408. In the case where the control unit 204 determines that the continuous printing is not possible, the control unit 204 terminates the process of flowchart illustrated in FIGS. 4A and 4B. Note that, in the case where the continuous printing is not possible, a process of displaying a warning screen is performed in the process of S407 as described later.

In S408, the control unit 204 displays a confirmation screen of the print jobs on the operation display unit 206.

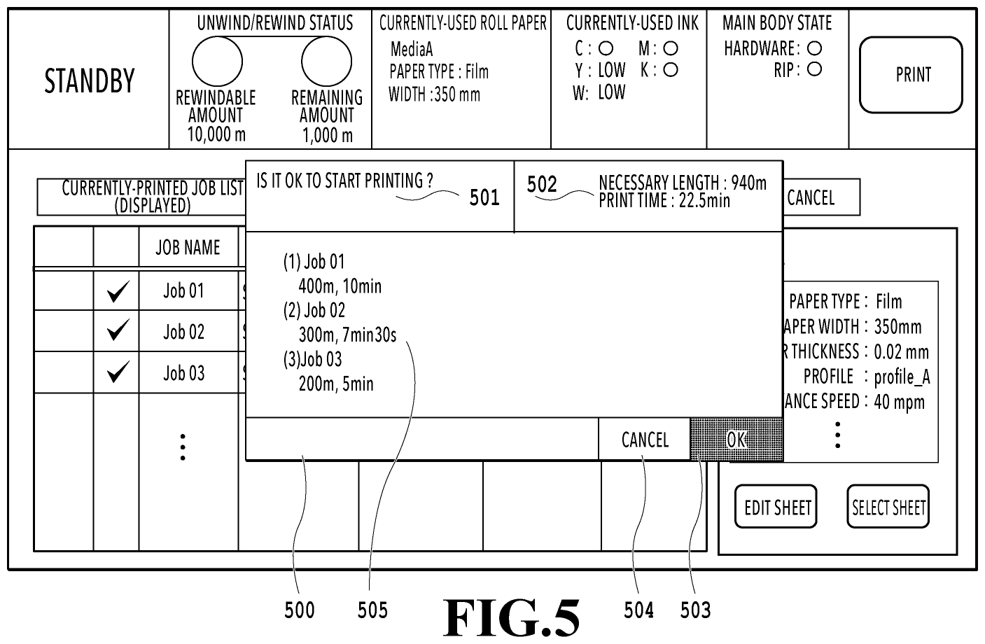

FIG. 5 is a diagram illustrating an example of a confirmation screen displayed in S408. The confirmation screen 500 is a screen displayed by being overlaid on the UI screen 300 illustrated in FIG. 3. Note that, although various screens to be explained later are similarly screens displayed by being overlaid on the UI screen 300, the screens are not limited to this form. The screens may be displayed instead of the UI screen 300 itself, and a display form of the screens may be any form.

The confirmation screen 500 includes a message 501 for confirmation of execution of printing, information 502 on the print length and print time necessary for the printing of the selected jobs, an OK button 503 for receiving the print instruction, and a cancel button 504 for cancelling the printing. The confirmation screen 500 also includes print information 505 such as a job name, the print length, and the print time of each of the selected jobs. In the confirmation screen 500 displayed in S408, since the printing is not stopped also in the case where the multiple jobs are continuously printed, warning notification is not performed unlike in other screen examples to be described later. After the process of S407, the control unit 204 terminates the process of flowchart illustrated in FIGS. 4A and 4B. Note that, based on an operation instruction by the user (for example, pressing operation of the OK button 503), the control unit 204 executes a process based on the received operation instruction as a subsequent process.

Returning to the explanation of the flowchart of FIG. 4B, in S409, the control unit 204 displays information indicating that the rewindable amount is insufficient on the operation display unit 206. The state of S409 is a state in which the paper feed remaining amount is sufficient but the rewindable amount is insufficient.

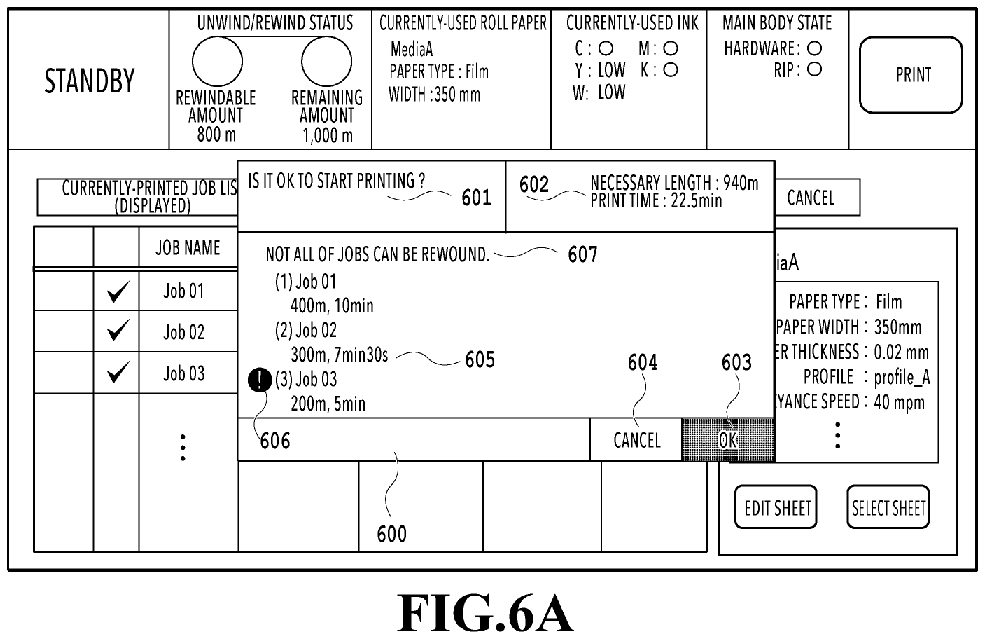

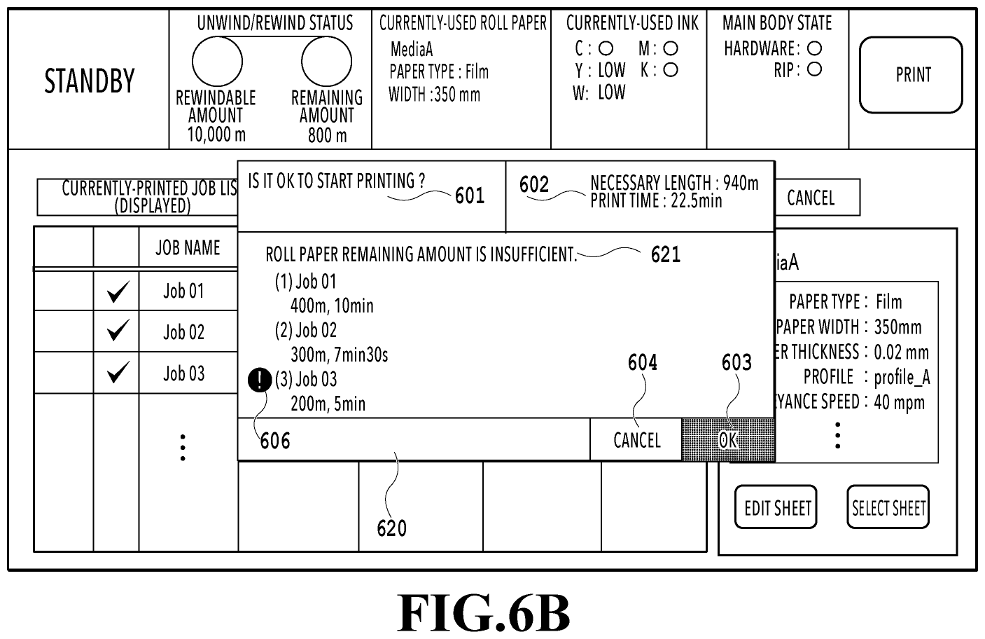

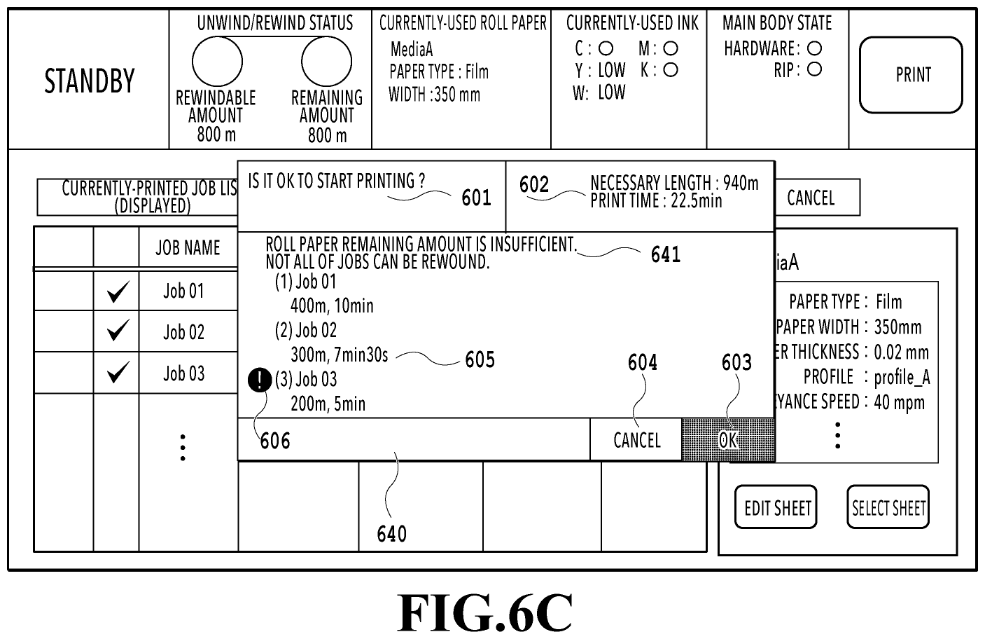

FIGS. 6A to 6C are diagrams illustrating examples of confirmation screens displayed in the case where the paper feed remaining amount or the rewindable amount is insufficient. FIG. 6A illustrates a confirmation screen 600 displayed in the case where the rewindable amount is insufficient. FIG. 6A illustrates an example in the case where the paper feed remaining amount is 1,000 m and the rewindable amount is 800 m. A total print length of Job01 and Job02 is 700 m, and Job01 and Job02 are printable. However, in the case where Job03 is added, the total print length is 900 m, and the rewindable amount is insufficient.

In S409, for example, the confirmation screen 600 is displayed on the operation display unit 206. The confirmation screen 600 includes a message 601 for confirmation of execution of printing, information 602 on the print length and the print time necessary for the printing of the selected jobs, an OK button 603 for receiving the print instruction, and a cancel button 604 for cancelling the printing. The confirmation screen 600 also includes a warning display area 605 that displays a warning message to the user and the print length and the print time of each of the selected jobs. Moreover, a warning message 607 indicating that not all of the jobs can be rewound is displayed in the confirmation screen 600. Furthermore, a warning mark 606 is attached to the job (Job03) that cannot be rewound in the case where the jobs are sequentially executed. The user can thereby recognize that the rewindable amount is insufficient at a time point after the pressing of the print button 303 and before execution of the printing of the first job. After S409, the control unit 204 proceeds to S413.

In S410, the control unit 204 compares the sheet length of the jobs calculated in S403 with the rewindable amount, and determines whether the rewindable amount is sufficient for the printing of the jobs. For example, the control unit 204 compares the calculated sheet length of the jobs with the rewindable amount included in the unwind rewind status display 304. In the case where the control unit 204 determines that the rewindable amount is sufficient, the control unit 204 proceeds to S411. In the case where the control unit 204 determines that the rewindable amount is insufficient, the control unit 204 proceeds to S412.

In S411, the control unit 204 displays information indicating that the paper feed remaining amount is insufficient on the operation display unit 206. The state of S411 is a state in which the rewindable amount is sufficient but the paper feed remaining amount is insufficient.

FIG. 6B illustrates an example of a confirmation screen 620 displayed in the case where the paper feed remaining amount is insufficient. In S411, for example, the confirmation screen 620 is displayed on the operation display unit 206. FIG. 6B is an example in the case where the paper feed remaining amount is 800 m and the rewindable amount is 1,000 m. The total print length of Job01 and Job02 is 700 m, and Job01 and Job02 are printable. However, the total print length of Job01 to Job03 is 900 m. Accordingly, the remaining amount of roll paper is insufficient in the case where Job03 is printed. A warning message 621 indicating that the roll paper remaining amount is insufficient is thus displayed on the confirmation screen 620. Moreover, the warning mark 606 is attached to the job (Job3) for which the paper cannot be fed in the case where the jobs are sequentially executed. The user can thereby recognize that the paper feed remaining amount is insufficient at the time point after the pressing of the print button 303 and before the execution of the printing of the first job. After S411, the control unit 204 proceeds to S413.

In S412, the control unit 204 displays information indicating that the paper feed remaining amount is insufficient on the operation display unit 206. The state of S412 is a state in which both of the paper feed remaining amount and the rewindable amount are insufficient.

FIG. 6C illustrates an example of a confirmation screen 640 displayed in the case where both of the paper feed remaining amount and the rewindable amount are insufficient. In S412, for example, the confirmation screen 640 is displayed on the operation display unit 206. FIG. 6C illustrates an example in the case where the paper feed remaining amount is 800 m and the rewindable amount is 800 m. The total print length of Job01 and Job02 is 700 m, and Job01 and Job02 are printable. However, the total print length of Job01 to Job03 is 900 m. Both of the remaining amount and the rewindable amount are thereby insufficient for printing of Job3. Accordingly, a warning message 641 indicating that the roll paper remaining amount is insufficient and that not all of the jobs can be rewound is displayed on the confirmation screen 640. Moreover, the warning mark 606 is attached to the job (Job03) for which the paper cannot be fed or rewound in the case where the jobs are sequentially executed. The user can thereby recognize that the paper feed remaining amount and the rewindable amount are insufficient at the time point after the pressing of the print button 303 and before the execution of the printing of the first job. After S412, the control unit 204 proceeds to S413.

In S413, the control unit 204 determines whether there is an unselected job in the print job list 308. In the case where there is an unselected job, the control unit 204 proceeds to S414. In the case where there is no unselected job, the control unit 204 terminates the process of flowchart illustrated in FIGS. 4A and 4B. In the examples illustrated in FIGS. 6A to 6C, there are three jobs in the print job list 308, and all jobs are in a selected state. Accordingly, in the examples of FIGS. 6A to 6C, the control unit 204 terminates the process of flowchart illustrated in FIGS. 4A and 4B. Note that subsequent processes are performed as appropriate based on a user instruction such as whether the OK button 603 is pressed by the user or whether the cancel button 604 is pressed by the user as described above. Note that, although the user is basically assumed to press the cancel button 604 and reselect jobs, a use case where the user desires to execute printing regardless of whether the printing is stopped halfway can be also assumed. Accordingly, in the case where the OK button 603 is pressed, the print process is started, though the printing is stopped between the jobs.

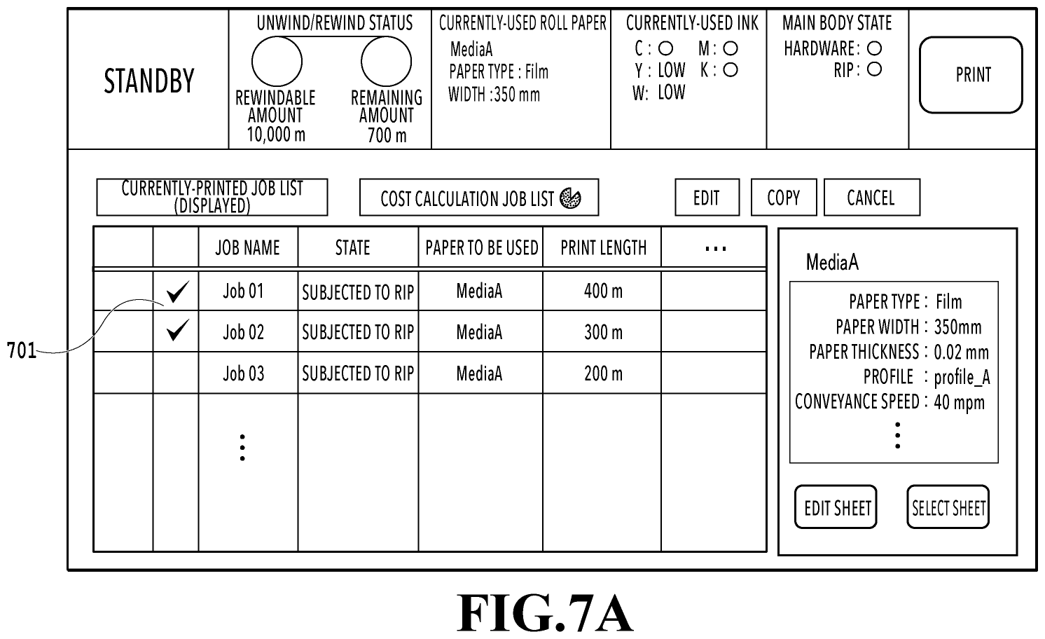

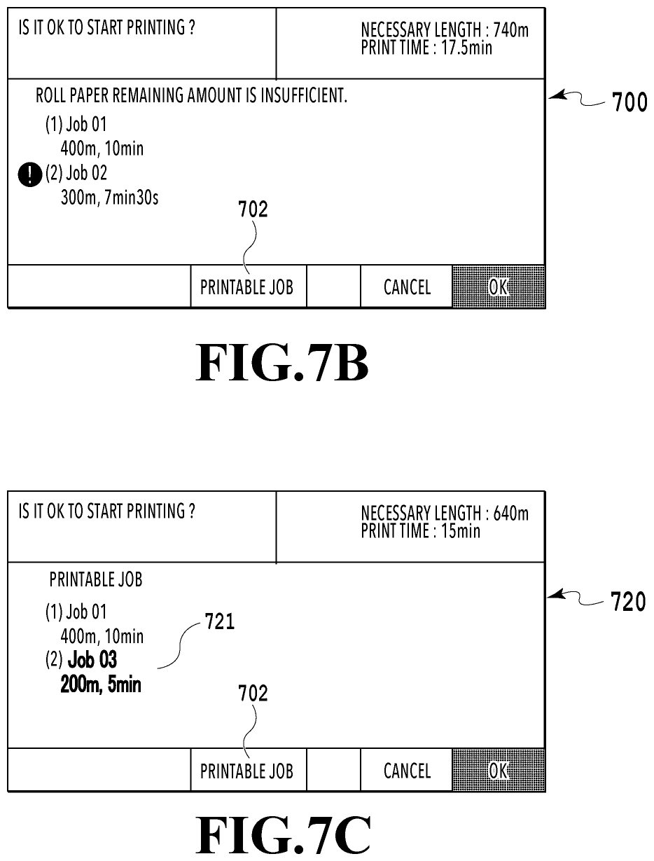

FIGS. 7A to 7C are diagrams illustrating other examples of display of printable jobs. The processes of S413 and beyond are explained by using FIGS. 7A to 7C. FIG. 7A illustrates an example of a state in which not all of the jobs in the print job list 308 are selected. In this example, Job01 and Job02 are selected, and the paper feed remaining amount is insufficient. Accordingly, in S411, a confirmation screen 700 illustrated in FIG. 7B is displayed on the operation display unit 206. In the confirmation screen 700, a printable job button 702 for selecting a printable job is displayed unlike the confirmation screen 620 illustrated in FIG. 6B.

In S414, the control unit 204 determines whether pressing of the printable job button 702 by the user is received. In the case where the control unit 204 receives the pressing of the printable job button 702, the control unit 204 proceeds to S415. In the case where the control unit 204 does not receive the pressing of the printable job button 702, the process of flowchart illustrated in FIGS. 4A and 4B is terminated.

In S415, the control unit 204 displays the printable job among the jobs subjected to RIP, on the operation display unit 206. A confirmation screen 720 of FIG. 7C illustrates a state where Job03 is selected as a print target job instead of Job02 for which the warning is displayed, Job03 being a job whose paper feed remaining amount necessary for printing is smaller than that of Job02. After S415, the control unit 204 terminates the process of flowchart illustrated in FIGS. 4A and 4B. As described above, in the case where at least one of the paper feed remaining amount and the rewindable amount is insufficient and there is an alternative job, the alternative job can be proposed to the user at a timing before the start of printing.

In the present embodiment, explanation is given of an example in which, in the case where there is an unselected job in the print job list 308, the confirmation screen 700 illustrated in FIG. 7B is displayed on the operation display unit 206. However, the present disclosure is not limited to this example. For example, a configuration may be such that the printable job button 702 as illustrated in FIG. 7B is displayed also in the state where all jobs in the print job list 308 are selected. Specifically, the configuration may be such that the printable job button 702 is displayed in all of FIGS. 6A to 6C.

FIG. 8 is a flowchart illustrating details of S403 of FIG. 4A. Specifically, FIG. 8 is a flowchart in which the sheet length is calculated from the selected jobs.

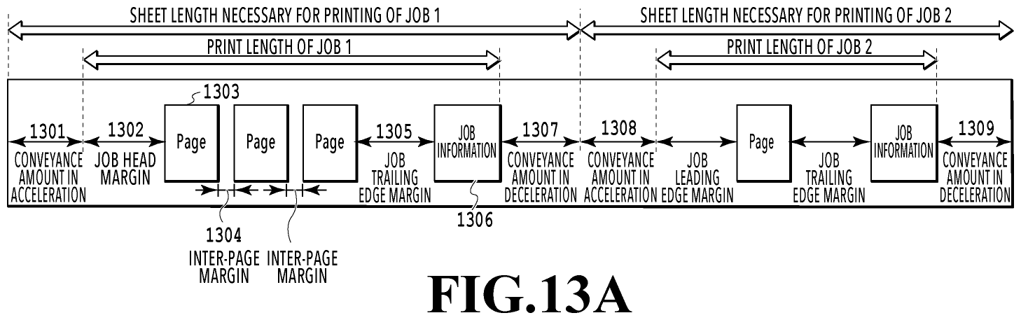

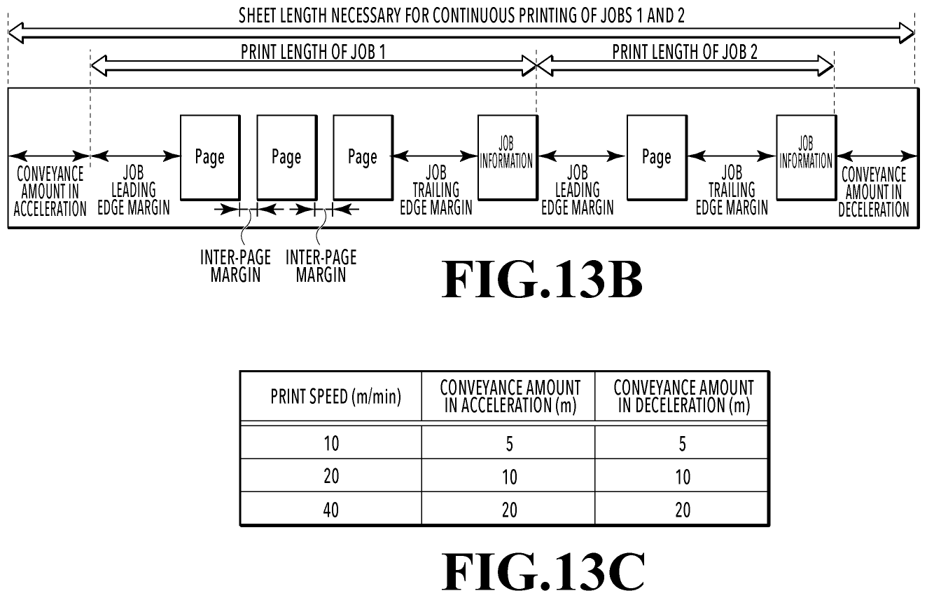

In S801, the control unit 204 assigns 0 to the sheet length L as an initial value. In S802, the control unit 204 determines a length L1 necessary in acceleration and a length L2 necessary in deceleration, from a print speed setting. In the image forming apparatus 100 of the present embodiment, printing is performed with the sheet conveyed at constant speed to maintain print quality. The length L1 necessary in acceleration is a sheet portion for reaching the constant speed. The length L2 necessary in deceleration is a sheet portion for normally stopping the sheet conveyance. Note that, in the case where the conveyance is stopped immediately after the completion of printing, printed pages are not discharged to the paper discharge device 105, and remain in the apparatus. The length L2 necessary in deceleration is also a sheet portion for discharging pages up to the last page to the paper discharge device 105. Specific number examples of L1 and L2 are described later in FIGS. 13A to 13C.

In S803, the control unit 204 adds L1 and L2 determined in S802 to the sheet length L. A repeated process of S804 is a process that is repeated as many times as the number of selected jobs. In S805, the control unit 204 determines a margin amount L3 from an inter-job margin setting. A specific example of an inter-job margin amount is described later in FIGS. 13A to 13C. In S806, the control unit 204 determines a print length L4 of the target job. Details of L4 are described later in FIGS. 13A to 13C. In S807, the control unit 204 determines a print length L5 of job information printing from a setting of job information printing. The job information printing is, for example, a portion of printing of a delivery number or the like. In S808, the control unit 204 adds L3, L4, and L5 to the sheet length L. Then, the control unit 204 terminates the process of flowchart illustrated in FIG. 8.

FIGS. 9A and 9B are totally a detailed flowchart of a process of checking the print settings of the jobs selected in S406 of FIG. 4B. The process of FIG. 9A and 9B is mainly a process of checking differences in print settings between the jobs. As described above, in the case where multiple jobs are selected, the print process is configured to be performed sequentially from the preceding job to the subsequent job. In this case, a process of determining the differences in print settings between a preceding job and the next job is performed in each job.

In S901, the control unit 204 determines whether the print medium of the preceding job and the print medium of the next job is the same. In the case where the control unit 204 determines that the print media are the same, the control unit 204 proceeds to S902. In the case where the control unit 204 determines that the print media are not the same, the control unit 204 proceeds to S907. In S907, the control unit 204 determines that roll paper replacement is necessary between the jobs, and determines to display a warning. Then, the control unit 204 proceeds to S908.

In S902, the control unit 204 determines whether the ink colors used in the preceding job and the ink colors used in the next job are the same. Specifically, the control unit 204 determines whether the ink colors used in the preceding job and the ink colors used in the next job are chromatic colors or both of chromatic colors and white. The chromatic colors are specifically colors of cyan (C), magenta (M), yellow (Y), and black (K). In other words, the control unit 204 determines whether printing is performed without using the white ink or is performed by using the white ink. In the case where the control unit 204 determines that the ink colors used in the preceding job and the ink colors used in the next job are the same, the control unit 204 proceeds to S903. In the case where the control unit 204 determines that the ink colors are not the same, the control unit 204 proceeds to S906.

In S903, in the case of white printing, the control unit 204 determines whether a contrast ratio setting of white in the preceding job and the contrast ratio setting of white in the next job are the same. Note that, in the case of chromatic color printing, the control unit 204 skips the process of S903, and proceeds to S904. In the present embodiment, there are two levels of the contrast ratio of white that are normal and high hiding power. However, the present disclosure is not limited to this, and the number of options may be increased. For example, there may be three levels of the contrast ratio of white that are low hiding power, normal, and high hiding power. In the case where the control unit 204 determines that the contrast ratios of white are the same, the control unit 204 proceeds to S904. In the case where control unit 204 determines that the contrast ratios of white are not the same, the control unit 204 proceeds to S906.

In S904, the control unit 204 determines whether an additional printing setting of the preceding job and an additional printing setting of the next job are the same. The additional printing setting is a setting of performing further printing on a print surface that has been already subjected to printing. In the case where the control unit 204 determines that the additional printing settings are the same, the control unit 204 proceeds to S905. In the case where the control unit 204 determines that the additional printing settings are not the same, the control unit 204 proceeds to S906.

In S905, the control unit 204 determines that the continuous printing of multiple jobs is possible. Then, the control unit 204 proceeds to S908.

As explained above, there is a case where the continuous printing impossible depending on the print settings, even if the print media are the same. For example, setting change of the printing apparatus is necessary between the case where the white ink is used and the case where no white ink is used. Accordingly, the printing is temporarily stopped. Similarly, setting change of the printing apparatus is necessary also in the case where the contrast ratio of white is changed in white printing. Accordingly, the printing is temporarily stopped. Moreover, setting change of the printing apparatus is necessary also in the case where the additional printing settings are not the same. Accordingly, the printing is temporarily stopped. The case where the control unit 204 proceeds to S905 is a case where stopping of the printing operation and changing of the print setting as described above do not occur. Accordingly, the control unit 204 determines that the continuous printing of multiple jobs is possible in S905.

In S906, the control unit 204 determines that the printing operation is to be stopped between the preceding job and the next job, and determines to display a warning. Then, the control unit 204 proceeds to S908.

In S908, the control unit 204 determines whether all jobs are checked. In the case where the control unit 204 determines that not all of the jobs are checked, the control unit 204 proceeds to S901. In the case where the control unit 204 determines that all jobs are checked, the control unit 204 proceeds to S909. The process of checking differences in print settings between each pair of jobs is performed as described above.

In S909, the control unit 204 determines whether to display a warning. In the process of the present flowchart, in the case where the control unit 204 has determined to display the warning in S906 or S907 for at least one pair of jobs, the control unit 204 determines to display the warning. In the case where the control unit 204 has never determined to display the warning in S906 or S907 for any of the pairs of jobs, that is, the control unit 204 has determined that the continuous printing is possible in S905 for all pairs of jobs, the control unit 204 determines not to display the warning. In the case where the control unit 204 determines to display the warning, the control unit 204 proceeds to S910. In the case where the control unit 204 determines not to display the warning, the control unit 204 terminates the process of flowchart illustrated in FIGS. 9A and 9B.

In S910, the control unit 204 displays the warning on the operation display unit 206.

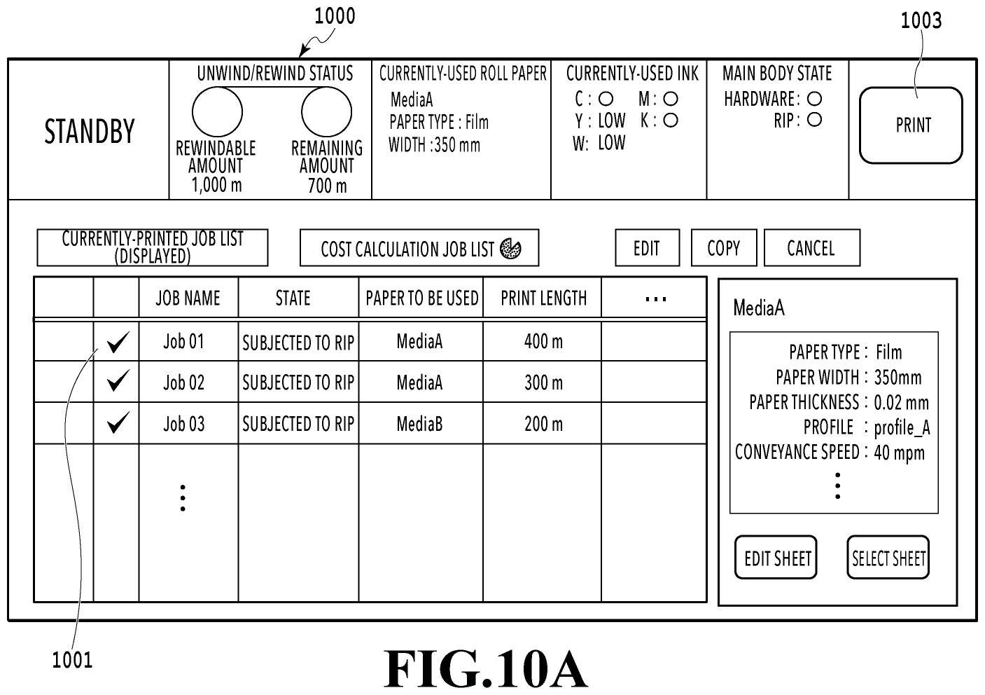

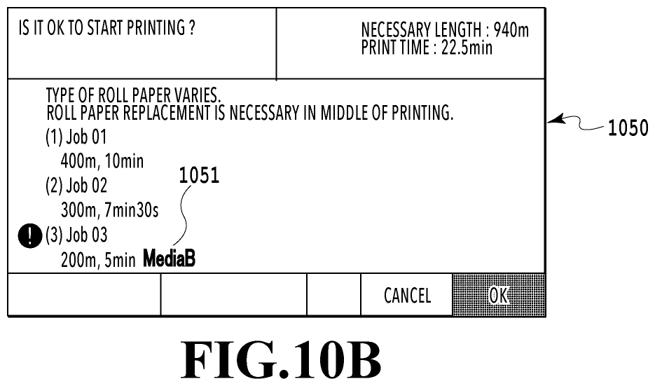

FIGS. 10A and 10B are diagrams illustrating examples of screens in which a warning is displayed. FIG. 10A and 10B are examples of screens in the case where the control unit 204 determines to display the warning in S907. FIG. 10A illustrates an example in which the print medium of Job3 out of the three jobs varies from those of the other jobs. Specifically, the print medium used in Job01 and Job02 is MediaA, while the print medium used in Job3 is MediaB. In the case where all jobs are selected with print selection checks 1001 and the control unit 204 receives pressing of a print button 1003 in this state, in S910, the control unit 204 displays a confirmation screen 1050 illustrated in FIG. 10B. In the present example, replacement of the roll paper is necessary before printing of Job03. Accordingly, the confirmation screen 1050 includes a message indicating that replacement of the roll paper is necessary in the middle of printing due to variations in types of print media. Moreover, the warning mark is attached to Job03 for which the replacement of the roll paper is necessary before printing. Furthermore, as illustrated in notification 1051, a type of print medium that varies is displayed in a highlighted manner.

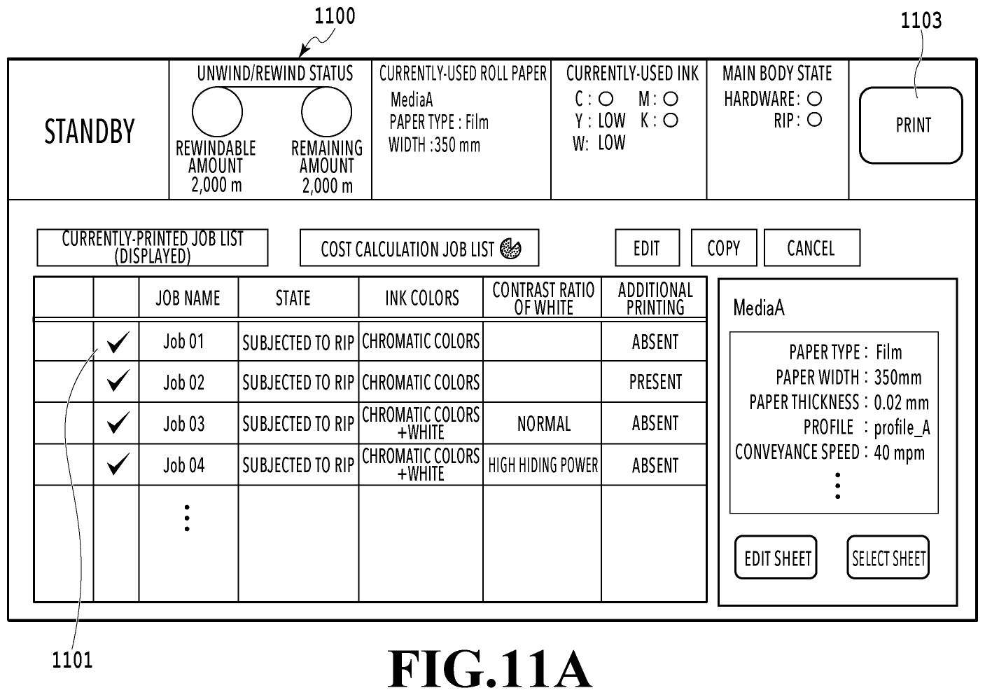

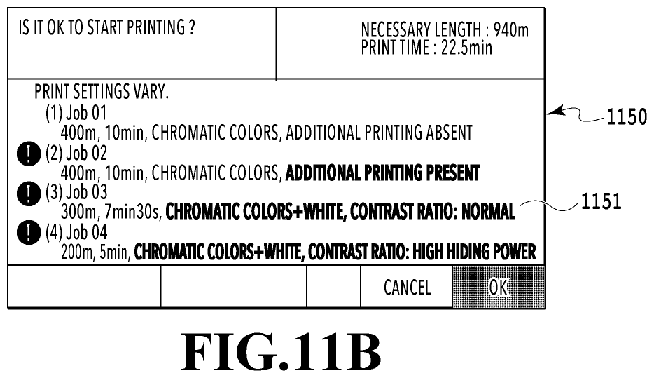

FIGS. 11A and 11B are diagrams illustrating examples of screens in which a warning is displayed. FIGS. 11A and 11B are examples of screens in the case where the control unit 204 determines to display the warning in S906. FIG. 11A illustrates that the settings of each of the jobs are as follows.

TABLE 1

| | | Contrast ratio | Additional |
|---|---|---|---|
| | Ink colors | of white | printing |
| Job01 | Chromatic colors | | Absent |
| Job02 | Chromatic colors | | Present |
| Job03 | Chromatic colors + white | Normal | Absent |
| Job04 | Chromatic colors + white | High hiding power | Absent |

In FIG. 11A, Job1 and Job2 among the four jobs vary in presence or absence of the additional printing setting. Job02 and Job03 vary in the setting of ink colors and presence or absence of the additional printing setting. Job03 and Job04 vary in the setting of contrast ratio of white. In the case where all jobs are selected with print selection checks 1101 and the control unit 204 receives pressing of a print button 1103 in this state, in S910, the control unit 204 displays a confirmation screen 1150 illustrated in FIG. 11B. The confirmation screen 1150 includes a message indicating that the print settings vary. Moreover, as illustrated in notification 1151, the print settings that vary between the jobs are displayed in a highlighted manner. After S910, the control unit 204 proceeds to S911.

In S911, the control unit 204 determines whether pressing of a print order optimization button by the user is detected. Explanation is given while using other confirmation screens different from those of FIGS. 10A to 11B as an example.

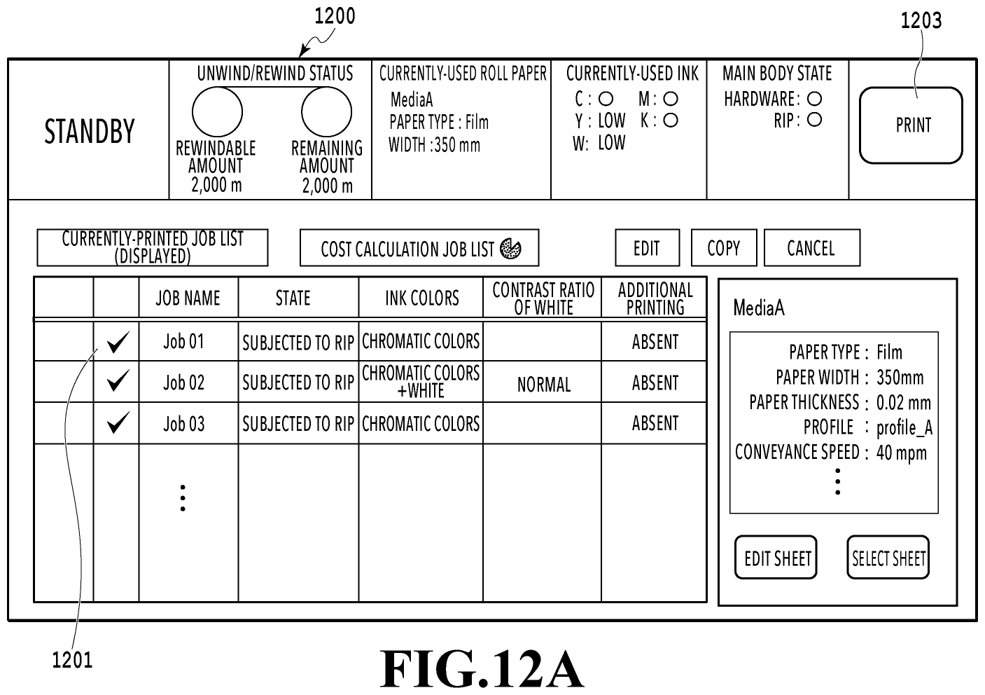

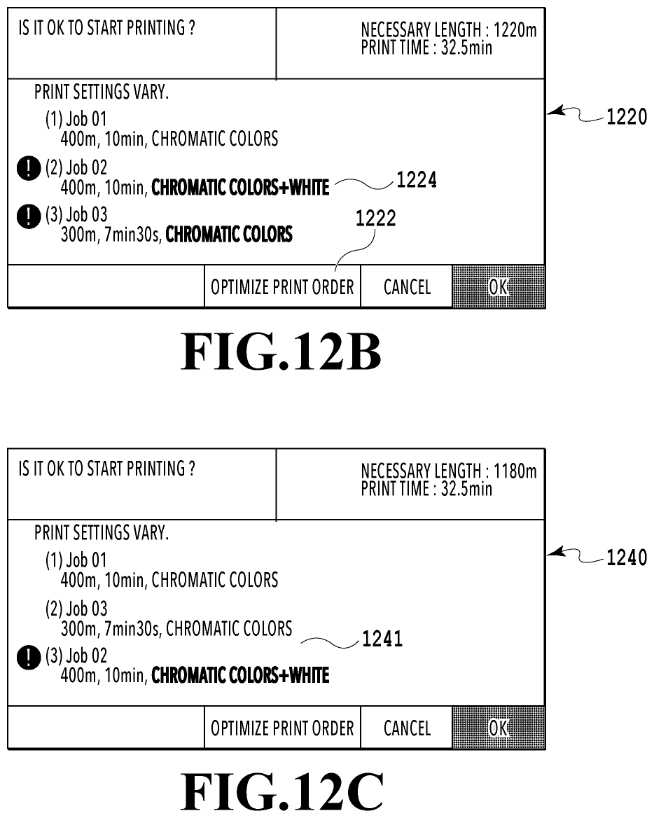

FIGS. 12A to 12C are diagrams illustrating examples of screens in which a warning is displayed, and are examples of screens displayed in S910. FIGS. 12A to 12C are examples of screens in the case where the control unit 204 determines to display the warning in S906. FIG. 12A illustrates that the settings of each job are as follows.

TABLE 2

| | | Contrast ratio | Additional |
|---|---|---|---|
| | Ink colors | of white | printing |
| Job01 | Chromatic colors | | Absent |
| Job02 | Chromatic colors + white | Normal | Absent |
| Job03 | Chromatic colors | | Absent |

In FIG. 12A, Job1 and Job2 among the three jobs vary in the setting of ink colors. Moreover, Job02 and Job03 vary in the setting of ink colors. Note that the print settings of Job01 are the same as the print settings of Job03. In the case where all jobs are selected with print selection checks 1201 and the control unit 204 receives pressing of a print button 1203 in this state, in S910, the control unit 204 displays a confirmation screen 1220 illustrated in FIG. 12B. The confirmation screen 1220 includes a message indicating that the print settings vary. Moreover, as illustrated in notification 1221, the print settings that vary between the jobs are displayed in a highlighted manner. Furthermore, the confirmation screen 1220 includes a print order optimization button 1222. In S911, the control unit 204 determines whether pressing of the print order optimization button 1222 is received. In the case where the control unit 204 determines that pressing of the print order optimization button 1222 is received, the control unit 204 proceeds to S912. In the case where the control unit 204 determines that pressing of the print order optimization button 1222 is not received, the control unit 204 terminates the process of flowchart illustrated in FIGS. 9A and 9B.

In S912, the control unit 204 determines the print order in which the jobs can be continuously printed. FIG. 12C illustrates a confirmation screen in a state where the order of Job02 and Job03 in FIG. 12B is switched based on reception of the pressing of the print order optimization button 1222 in FIG. 12B. Note that, since there is still variation in the ink colors between Job03 and Job02, the warning by notification 1241 is continuously displayed. After the process of S912, the control unit 204 terminates the process of flowchart illustrated in FIGS. 9A and 9B.

Note that, in a form in which no print order optimization button is prepared as illustrated in FIGS. 10A to 11B, the configuration may be such that the processes of S910 and S911 are skipped.

FIGS. 13A to 13C are diagrams explaining calculation of the sheet length. FIG. 13A illustrates an example in which job 1 and job 2 are printed one by one. Values determined from the print speed are used as a conveyance amount 1301 in acceleration and a conveyance amount 1307 in deceleration. In explanation in contrast to the example of FIG. 8, the conveyance amount 1301 in acceleration is L1, and the conveyance amount 1307 in deceleration is L2.

As illustrated in FIG. 13A, the print length of job 1 is as follows.

Print length=job head margin 1302+job trailing edge margin 1305+(page size 1303+inter-page margin 1304)×(number of pages×number of copies)+page size 1306 of job information

The job head margin 1302 and the job trailing edge margin 1305 correspond to sheet portions in which the print surface is covered with the roll paper. In explanation in contrast to the example of FIG. 8, the margin amount L3 corresponds to the job head margin 1302, the job trailing edge margin 1305, and the inter-page margin 1304. Moreover, the print length L4 corresponds to the page size 1303. The print length L5 of the job information printing corresponds to the page size 1306 of job information.

The sheet length necessary for printing of job 1 is as follows.

Sheet length=print length of job 1+conveyance amount 1301 in acceleration+conveyance amount 1307 in deceleration

FIG. 13A is an example in which jobs are printed one by one. Accordingly, printing is temporarily stopped after printing of job 1, and then printing of job 2 is started. Thus, conveyance amount 1301 in acceleration+conveyance amount 1307 in deceleration becomes necessary again in the sheet length necessary for job 2.

FIG. 13B illustrates an example in which job 1 and job 2 are continuously printed. Since job 2 is continuously printed after printing of job 1, the printing requires only one conveyance amount 1301 in acceleration and one conveyance amount 1307 in deceleration. Accordingly, waste paper can be reduced.

FIG. 13C illustrates values of the conveyance amount in acceleration and the conveyance amount in deceleration with respect to the print speed. For example, the conveyance amount in acceleration is 20 m and the conveyance amount in deceleration is 20 m with respect to the print speed of 40 m/min. Note that these values are examples, and the conveyance amounts are not limited to these values. For example, the conveyance amount in acceleration may be 10 m with respect to the print speed of 40 m/min. Moreover, the conveyance amount in deceleration does not have to take the same value as the conveyance amount in acceleration.

As explained above, according to the present embodiment, notification can be made at an appropriate timing in the case where printing is continuously performed by using multiple print jobs. Specifically, in the present embodiment, in the case where multiple jobs are to be continuously printed on the roll paper, it is possible to check whether the printing is to be interrupted between the continuously-printed jobs, before the start of continuous printing. For example, it is possible to determine whether the sheet remaining amount is sufficient and whether the rewindable amount is sufficient, before the start of printing. Accordingly, it is possible to perform preliminary work such as preliminary replacement of the roll paper, take-out of the roll paper from the paper discharge device, and reduction of jobs to be printed. Moreover, the print settings are checked in selection of multiple jobs, and the warning is displayed in the case where a print setting varies between the jobs. This allows the print order of the jobs to be changed such that the jobs are printed in the order optimized for the continuous printing.

### Other Embodiments

In the above-mentioned embodiment, explanation is given of the example in which the process of checking the print settings of the selected jobs in S406 is performed in the case where both of the paper feed remaining amount and the rewindable amount are sufficient. However, the present disclosure is not limited to this example. The check process in S406 and the display process of the confirmation screen in S407 subsequent to S406 may be performed also in the case where at least one of the paper feed remaining amount and the rewindable amount is insufficient. In the confirmation screen, the warning indicating that a print setting varies may be displayed in addition to the warning that at least one of the paper feed remaining amount and the rewindable amount is insufficient. Specifically, for the subsequent job for which at least one of the paper feed remaining amount and the rewindable amount is insufficient, the warning indicating that at least one of the paper feed remaining amount and the rewindable amount is insufficient is displayed. Moreover, the configuration may be such that, in the case where a print setting varies between the subsequent job and the preceding job for which the paper feed remaining amount and the rewindable amount are sufficient, the warning indicating that the print setting varies may be displayed near the preceding job.

Moreover, the configuration may be such that, also in the case where another printable job is set instead as the print target job in S414, the control unit 204 checks the print settings and displays the warning as described above as appropriate.

In a specific example explained in FIGS. 6A to 6C, explanation is given of the example in which the paper feed remaining amount or the rewindable amount is insufficient for the total print length obtained by adding up the print lengths of the jobs. Although no specific example is described above, there is a situation where the warning as illustrated in FIGS. 6A to 6C is displayed even in the case where the paper feed remaining amount and the rewindable amount exceed the total print length obtained by adding up the print lengths of the jobs. Specifically, in a situation where the paper feed remaining amount or the rewindable amount is insufficient for the sheet length that is a value obtained by adding the conveyance amounts in acceleration and deceleration to the total print length, the warning as illustrated in FIGS. 6A to 6C or the like is displayed even in the case where the paper feed remaining amount or the rewindable amount is sufficient for the total print length.

Moreover, in the examples of FIGS. 7A to 7C, explanation is given of the example in which, in the case where the printable job button 702 is pressed, the control unit 204 adds Job03 instead of Job02 that is the subsequent job out of the continuous jobs. However, Job3 may be added instead of Job01 that is the preceding job out of the continuous jobs.

Moreover, in the embodiment described above, explanation is given of the example in which the jobs included in the print job list are jobs in which vector image data is already converted to raster image data. However, the present disclosure is not limited to this. The jobs selected in S401 may be jobs not subjected to the RIP process. In this case, the control unit 204 only needs wait for completion of the RIP process on the target jobs, and then calculate the sheet length.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-084669, filed May 24, 2024, which is hereby incorporated by reference wherein in its entirety.

What is claimed is:

1. An image forming apparatus comprising:
one or more memories storing instructions; and
one or more processors executing the instructions to:
perform a reception process of receiving a print instruction of continuously printing a plurality of jobs including a second job subsequent to a first job; and
perform a control process of controlling output of predetermined notification before execution of a print process of a foremost job among the plurality of jobs, based on reception of a print instruction for the foremost job, in a case where a condition in which a print process is interrupted after completion of printing of the first job and before start of printing of the second job is satisfied in the reception of the print instruction.

2. The image forming apparatus according to claim 1, wherein the one or more processors further executes the instructions to:
obtain a paper feed remaining amount and a rewindable amount of a print medium set in the image forming apparatus; and
determine a sheet length necessary in a case where the plurality of jobs are to be continuously printed, and
in the control process, the condition in which the print process is interrupted is determined to be satisfied in a case where at least one of the paper feed remaining amount and the rewindable amount is insufficient for the sheet length.

3. The image forming apparatus according to claim 2, wherein the sheet length is a length including print lengths of the respective jobs, a conveyance amount necessary in acceleration, and a conveyance amount necessary in deceleration.

4. The image forming apparatus according to claim 3, wherein the print lengths of the respective jobs are lengths including a margin amount between the jobs and a region in which information on the jobs is printed, in addition to regions of pages to be printed.

5. The image forming apparatus according to claim 1, wherein, in the control process, the condition in which the print process is interrupted is determined to be satisfied in a case where a print setting varies between jobs in the plurality of jobs.

6. The image forming apparatus according to claim 5, wherein the print setting includes at least one of a type of the print medium, an ink color to be used, a contrast ratio of white ink, and a setting of additional printing.

7. The image forming apparatus according to claim 1, wherein
in the reception process, a print instruction of a plurality of jobs selected from a list of inputted jobs is received,
in the control process, in a case where there is an unselected job in the list of jobs, a third job that involves no interruption of the print process is determined as a target of the print process instead of the second job.

8. The image forming apparatus according to claim 1, wherein, in the control process, an order of the second job and another job among the plurality of jobs is switched.

9. The image forming apparatus according to claim 1, wherein, in the control process, notification indicating that the print process is to be interrupted is displayed on a display unit as the predetermined notification.

10. The image forming apparatus according to claim 1, wherein the predetermined notification includes a warning mark for the second job.

11. The image forming apparatus according to claim 1, wherein
the predetermined notification includes a region configured to receive an instruction of selecting another job, and
in the control process, in a case where the instruction of selecting another job is received, a third job that involves no interruption of the print process is determined as a target of the print process instead of the second job.

12. The image forming apparatus according to claim 1, wherein
the predetermined notification includes a region configured to receive an instruction of optimizing an order of jobs, and
in the control process, in a case where the instruction of optimizing the order of jobs is received, the order of the second job and another job among the plurality of jobs is switched.

13. The image forming apparatus according to claim 1, wherein the plurality of jobs are jobs in which vector image data included in the jobs has been converted to raster image data.

14. A control method of an image forming apparatus, the control method comprising:
receiving a print instruction of continuously printing a plurality of jobs including a second job subsequent to a first job; and
controlling output of predetermined notification before execution of a print process of a foremost job among the plurality of jobs, based on reception of a print instruction for the foremost job, in a case where a condition in which a print process is interrupted after completion of printing of the first job and before start of printing of the second job is satisfied in the reception of the print instruction.

15. A non-transitory computer readable storage medium storing a program which causes a computer to execute:
receiving a print instruction of continuously printing a plurality of jobs including a second job subsequent to a first job; and
controlling output of predetermined notification before execution of a print process of a foremost job among the plurality of jobs, based on reception of a print instruction for the foremost job, in a case where a condition in which a print process is interrupted after completion of printing of the first job and before start of printing of the second job is satisfied in the reception of the print instruction.
